(19) United States
(12) Patent Application Publication
(10) Pub. No.: US 2015/0275050 A1
(43) Pub. Date: Oct. 1, 2015

(54) NONHALOGENATED FLAME RETARDANT COMPOSITIONS AND ARTICLES

(71) Applicant: 3M INNOVATIVE PROPERTIES COMPANY, Saint Paul, MN (US)

(72) Inventors: Su Wei-Cheng, Taiwan (CN); Plepys R. Anthony, Austin, TX (US); Pyun Eumi, Austin, TX (US); Rosner B. Robert, Austin, TX (US)

(73) Assignee: 3M INNOVATIVE PROPERTIES COMPANY, Saint Paul, MN (US)

(21) Appl. No.: 14/438,049

(22) PCT Filed: Oct. 31, 2013
(86) PCT No.: PCT/US2013/067658

§ 371 Date: Apr. 23, 2015

Related U.S. Application Data
(60) Provisional application No. 61/721,220, filed on Nov. 1, 2012.

(51) Int. Cl. C09J 7/02; C09K 21/12

(52) U.S. Cl. CPC C09J 7/0246; C09K 21/12; C09J 133/08

(57) ABSTRACT

Flame retardant adhesives and tape articles include a nonhalogenated flame retardant component comprising a combination of melamine cyanurate and aluminum phosphinate.

### FIELD

This disclosure relates to compositions and articles that include a nonhalogenated flame retardant composition.

### BACKGROUND

Flame retardant adhesive compositions and tape articles are used in many industries and for many different purposes. They are used, for example, in the electrical industry in insulating tapes. Flame retardant compositions, widely used in flame retardant adhesives and tapes, often use one or more halogen-containing materials. However, environmental and safety concerns regarding use of halogen-containing materials in adhesives and related articles have been raised. In response to these concerns, many nonhalogenated flame retardant materials have been introduced to be used in place of halogen-containing materials.

### SUMMARY

At least one embodiment of the present invention provides a composition comprising at least one adhesive; and a flame retardant component, wherein the flame retardant component comprises both a melamine cyanurate and an aluminum phosphinate.

At least one embodiment of the present invention provides an article comprising a backing layer having two opposed, major surfaces, an adhesive disposed on at least one of the major surfaces of the backing layer, and a flame retardant component comprising a melamine cyanurate and an aluminum phosphinate, the flame retardant component being disposed in the backing layer, on the backing layer, or a combination thereof.

The present inventors found that compositions containing aluminum phosphinates, including aluminum hypophosphite, flame retardants alone were able to pass the UL510 flammability test but achieved only a CTI rating of II, and compositions containing melamine cyanurate flame retardants alone did not pass UL510 flammability testing. However, the inventors found, unexpectedly, that when the two types of flame retardants were used together, the resulting compositions both achieved a CTI rating of I and passed UL510 flammability testing.

Embodiments of the present invention provide adhesive compositions and tape articles that offer desired flame retardant properties, in addition to favorable dielectric breakdown values and CTI ratings. The adhesive compositions and tape articles are suitable for use in many applications. Their combination of properties makes them particularly suitable for electrical insulation material, for example in transformers, power supply units, or similar devices.

The above summary is not intended to describe each disclosed embodiment of every implementation of the present disclosure. The detailed description which follows more particularly exemplifies illustrative embodiments.

### DETAILED DESCRIPTION

It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

In this disclosure,

“aluminum phosphinate” refers to aluminum phosphinate salts having the general structure shown below, in which M refers to aluminum and n=3, and wherein R1 and R2 can be hydrogen and/or an alkyl group containing between 1 and 6 carbon atoms.

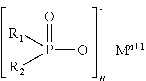

Examples of aluminum phosphinates include aluminum hypophosphite, having the formula [H₂PO₂⁻]₃ Al³⁺, in which R1 and R2 are hydrogen atoms, and diethyl aluminum phosphinate, in which R1 and R2 are ethyl groups.

“halogen-free” and “nonhalogenated” are used interchangeably herein and refer to the total or substantial absence, e.g., trace or ineffective amounts, of halogens, i.e., fluorine, chlorine, bromine, iodine, and astatine;

“flame retardant components” refers to halogen-free or nonhalogenated flame retardant or flame resistant components;

“flame retardant materials” refer to one or more nonhalogenated flame retardant materials that make up the flame retardant components; and

“flame retardant adhesives and/or tapes” refer to adhesives and tapes incorporating flame retardant components that can pass the requirements set forth by the flame test of industry standard UL 510 (Underwriters Laboratories Inc., Eighth Edition).

Embodiments of adhesives and tapes of the present invention used in electrical applications should provide acceptable electrical insulation. Electrical insulation properties can be measured in several ways. One is the requirements of UL 510 regarding dielectric strength, before and after humidity exposure, and insulation resistance. The UL 510 requirements are based on ASTM D-149-97a (Standard Test Method for Dielectric Breakdown Voltage and Dielectric Strength of Solid Electrical Insulating Materials at Commercial Power Frequencies, 2004), which provides standard procedures for determining dielectric strength of solid insulating materials at commercial power frequencies, under specified conditions. Another way is the Comparative Tracking Index (“CTI”). The CTI test is used to measure material degradation properties under electrical stress (tracking) of an insulating material as set forth in ASTM D3638-07 (Standard Test Method for Comparative Tracking Index of Electrical Insulating Materials, 2007).

An adhesive or a tape can be considered flame retardant when it can inhibit or resist spread of fire. According to the flame test described in UL510 standard, for an adhesive or a tape test specimen to be considered flame retardant, when a test flame is applied to the test specimen, it cannot flame longer than 60 seconds following any of five 15 seconds applications of the test flame, the period between applications being: a) 15 seconds if the specimen flaming ceases within 15 seconds; or b) the duration of the specimen flaming if the specimen flaming persists longer than 15 seconds. The test specimen should not ignite combustible materials in its vicinity or damage more than 25 percent of an indicator flag during, between, or after the five applications of the test flame.

The flame retardant components of the present invention are nonhalogenated and include a combination of particular flame retardant materials: melamine cyanurate and aluminum phosphinate. Optionally, the flame retardant components of the present invention may also include one or more additional nonhalogenated flame retardant materials such as alumina trihydrate (Al₂O₃.3H₂O) and magnesium hydroxide (Mg(OH)₂). Commercially available examples of additional aluminum trihydrate flame retardants include, but are not limited to those available under the trade designations HYMOD (Huber Corp., Edison, N.J.) or POLYFILL (R. E. Carroll, Inc., Trenton, N.J.). Care should be taken not to add amounts these materials that would lower the CTI rating of the flame retardant components. The flame retardant components of the present invention may be part of the adhesive composition or may be incorporated into the tape construction, such as in the tape backing, or disposed on the tape backing as a separate layer, or a combination thereof.

The melamine cyanurate portion of the flame retardant component is represented by:

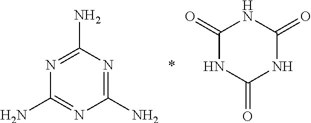 [SMILES: Nc1nc(N)nc(N)n1 ; O=c1[nH]c(=O)[nH]c(=O)[nH]1]

Commercially available examples of suitable melamine cyanurates include, but are not limited to those available under the trade designations MCA 300, available from Green Yard, Taiwan; MELAPUR MC 15, available from Ciba (now part of BASF), Germany; CG-610, available from Chemgarde, Taiwan.

The aluminum phosphinate of the flame retardant component is represented by:

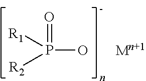

Where n=3 and wherein R1 and R2 can be hydrogen and/or an alkyl group containing between 1 and 6 carbon atoms.

Commercially available examples of suitable aluminum phosphinates include, but are not limited to those available under the trade designations OP935 (aluminum diethylphosphinate), available from Clariant, Germany.

In embodiments in which the aluminum phosphinate of the flame retardant component is an aluminum hypophosphite, it is represented by:

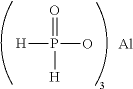

Commercially available examples of suitable aluminum hypophosphites include, but are not limited to those available under the trade designations PHOSLITE B85AX available from Italmatch Chemicals, Italy.

The weight ratio of melamine cyanurate to aluminum phosphinate may be from about 1:3 to about 1:1.

The total amount of flame retardant components as well as the amounts of each of the flame retardant materials that make up the total amount of flame retardant component may be varied over a wide range but are present in an amount sufficient to render the adhesive or tape flame retardant. As the total amount of flame retardant component and/or the relative amounts of flame retardant materials that make up the flame retardant are changed, the performance properties such as adhesion may be adversely affected depending on the intended application of the adhesive or tape. In at least some embodiments of the present invention, a preferred lower limit for the flame retardant component in the flame retardant adhesive or tape backing can be about 30% by weight (30 wt%), and in some cases about 35 wt % and yet in other cases about 38 wt %. In at least some embodiments of the present invention, a preferred upper limit can be about 60 wt %, and in some cases about 50% wt % and yet in other cases about 40 wt %.

In some embodiments, the disclosed flame retardant component offers desired flame retardant properties without substantially affecting functional performance of the adhesives and tapes, such as failure of adhesion to an intended surface or reduction in insulating properties of an insulating tape. Exemplary adhesive and tape constructions with flame retardant components containing appropriate amounts of the combination of aluminum phosphinate and melamine cyanurate, together with or without one or more additional flame retardant materials incorporated, show advantageous properties and characteristics in comparison to their properties individually. Specifically, as shown in Tables 2 and 3, when melamine cyanurate flame retardant materials are used alone in adhesives or tape constructions they fail the UL 510 flammability test and when aluminum phosphinate flame retardant materials are used alone in adhesives or tape constructions they pass UL 510 flammability testing but only achieve a Comparative Tracking Index (“CTI”) rating of II. The formation of char, which enables advantageous flame retardancy, has a negative effect on CTI rating; this is one reason that it is difficult to achieve both flame retardancy and a high CTI rating. When the aluminum phosphinate flame retardant materials are used in combination with alumina trihydrate nonhalogenated flame retardant material in adhesives or tape constructions, they pass UL 510 flammability testing but only achieve a CTI rating of II. Surprisingly, synergistic results are obtained when aluminum phosphinate and melamine cyanurate flame retardant materials are used together in adhesives or tape constructions whereby both CTI ratings of I and passing results of the UL 510 flammability test are achieved. For example, as shown in Tables 2 and 3, adhesives and tape constructions with the aluminum phosphinate and melamine cyanurate flame retardant component of the present invention can pass the industry standard UL 510 flame retardancy test and can achieve a CTI rating of I, which is the highest CTI rating possible. Achieving a CTI rating of I is of particular importance for electronics applications. The CTI rating of insulating tapes is used to determine the barrier width or creepage distance allowed between conductive parts in transformers. A higher CTI rating of the insulating layer permits the construction of smaller transformers. Presently, there may be few, if any, insulating tapes that meet all three of these highly desirable characteristics: non-halogenated, flame retardant per UL510 requirements, and achieving a CTI rating of I.

In some embodiments of the present invention, the flame retardant components can be included within an adhesive material to impart desired flame retardant properties to the adhesives. Useful adhesives include many different types and forms, such as pressure sensitive adhesives, thermoset adhesives, hot-melt adhesives, and other types of adhesives. As is well known in the art, when described by their relative chemical compositions, adhesives may be grouped as acrylic adhesives, polyolefin adhesives, styrenic co-polymer adhesives, silicone adhesives, epoxy adhesives, ethylene co-polymer adhesives, and other types of adhesives. The provided nonhalogenated flame retardant components may be incorporated into any of these adhesive materials to impart desired flame retardant properties to the adhesives. Particular use may be found with acrylic-based pressure sensitive adhesives. Suitable acrylics include, but are not limited to, 2-ethyl hexyl acrylate, and acrylic acid copolymers, and combinations thereof.

The provided flame retardant components may also be used in adhesives or tape constructions together with other materials. Many adhesives, for example, include one or more cross-linking compositions such as, for example, bisamide-type cross-linkers and organometallic compounds such as aluminum acetylacetonate (AAA.)

Adhesives or tape constructions also often incorporate one or more tackifier compound to manage a desired tack characteristic of the adhesive or tape. Suitable tackifiers include, for example, esters of rosin, such as SYLVALITE RE 80HP, available from Arizona Chemical, USA. Inclusion of other customary additives, adjuvants, agents and materials (e.g., colorants, pigments, primers, fillers, UV absorbers, and conductive particles) are understood by those skilled in the art.

Adhesives incorporating the flame retardant components of the present invention may be used in any application for which the underlying adhesive without the flame retardant component is intended and for which a degree of flame retardancy is desired. The flame retardant components of the present invention also find particular utility in tape constructions. Such tape constructions generally comprise a backing material onto which one or more functional or structural layers are applied (typically by coating). One or more of the flame retardant components of the present invention may be used in or with such tape constructions by incorporating the flame retardant components into the backing material and/or one or more of the functional or structural layers. The flame retardant components may, for example, be incorporated into an adhesive which is applied to a backing material, or it may be applied as, or together with, a non-adhesive layer, such as a primer layer, within the tape construction independent of an adhesive layer. There is, therefore, great flexibility in the utility of the provided flame retardant components within a tape construction.

In at least one embodiment of the present invention, a multi-layered tape construction includes a flame retardant adhesive applied to a backing material having at least two major surfaces. The flame retardant adhesive is provided as a layer applied to one of the major surfaces of the backing material. The flame retardant adhesive layer can be of any desired and workable thickness, but is generally in the range from about 12 μm to about 80 μm or even possibly more, typically from about 25 to about 35 μm. The backing material is, typically, free of halogen-containing compounds. Suitable backing materials include, for example: polymer materials such as polyesters (e.g., PET (polyethylene terephthalate)), polyolefins, polyamides and polyimides; natural and synthetic rubber materials; paper materials; metal foils, glass cloths; and other types of materials. The backing material can be of any desired and workable thickness, but is generally between about 25 μm and about 125 μm thick.

Tape constructions that include the flame retardant components of the present invention can include a primer disposed between a flame retardant adhesive and a backing material. An example of a suitable primer is a solvent-based composition with acrylonitrile-butadiene polymer, fatty acids, and alcohol. Flame retardant tape constructions may also include a low adhesion backsize (or “LAB”) material on the major surface of the backing material opposite the major surface carrying the adhesive and, if present, the primer. The low adhesion backsize material can help prevent individual pieces of tape from adhering to each other when a roll is manufactured and wound.

Although the aforementioned detailed description contains many specific details for purposes of illustration, one of ordinary skill in the art will appreciate that many variations, changes, substitutions, and alterations to the details are within the scope of the disclosure as claimed. Accordingly, the disclosure described in the detailed description is set forth without imposing any limitations on the claimed disclosure. The proper scope of the disclosure should be determined by the following claims and their appropriate legal equivalents. All of the references cited are herein incorporated by reference in their entirety.

### EXAMPLES

The following examples and comparative examples are offered to aid in the understanding of the present invention and are not to be construed as limiting the scope thereof. Unless otherwise indicated, all parts and percentages are by weight. The following test methods and protocols were employed in the evaluation of the illustrative and comparative examples that follow:

### Test Methodologies

### 1. UL 510 Flammability Test:

A specimen is exposed to an open flame for a period of fifteen seconds. Upon exposure to the flame, any flame on the test specimen (which typically catches fire) must extinguish in less than 60 seconds to pass the test. The test is repeated five times. Any extinguishing time longer than 60 seconds is considered a failure for the specimen. Results are reported as “Pass” or “Fail.” Further information regarding the test may be found in the description of the UL 510 standard published by Underwriters Laboratory of Northbrook, Ill., USA.

### 2. UL 510 Ratio of Wet to Dry Dielectric Strength:

Testing for dry and wet dielectric strength was performed according to the protocol of ASTM D149-09. In general, according to this test a sample is placed between two electrodes and power is increased until there is a dielectric failure. Testing for “dry” dielectric strength was performed at room temperature and 50% relative humidity. Testing for “wet” dielectric strength was performed upon exposure of the sample for 96 hours at 23° C. and 96% relative humidity. To pass the dry dielectric strength test, the dielectrics must be greater than or equal to 1000 V/mil. To pass the wet dielectric strength test, at least 90% of the dry dielectric strength must be retained (i.e., the wet dielectrics are greater than or equal to 900 V/mil). To pass UL510, the ratio of wet dielectric breakdown/dry dielectric breakdown must be greater than 90%.

### 3. Comparative Tracking Index (“CTI”):

The Comparative Tracking Index (or “CTI”) of a material is a measure of the resistance of a material to surface tracking under defined test conditions. The protocol for the test is set forth in ASTM D3638-07. In general, to perform the test the upper surface of a test specimen is supported in an approximately horizontal plane and subjected to an electrical stress via two electrodes. The surface between the electrodes is subjected to a succession of drops of an electrolyte solution until the over-current device operates, until a persistent flame occurs or until the testing period has elapsed. Individual tests are of short duration (less than 1 hour) with up to 50 or 100 drops of about 20 mg of electrolyte solution falling at 30 second intervals between platinum electrodes spaced 4.0 mm apart on the test specimen surface. An alternating current voltage between 100 V and 600 V is applied to the electrodes during the test.

Results are plotted to record the number of drops of electrolyte solution placed on the surface of the specimen versus the recorded voltage. The Comparative Track Index, or CTI, represents the voltage corresponding to 50 drops of electrolyte solution. The lower the CTI rating for a given material, the greater is the creepage distance associated with that material. A CTI Rating is specified as follows:
CTI Rating I: CTI>600 V
CTI Rating II: 400 V<CTI<600 V
CTI Rating Ma: 175 V<CTI<400 V
CTI Rating Mb: 100 V<CTI<175 V

### 4.UL 510 Adhesion to Steel:

The UL 510 Adhesion to Steel standard requires an adhesion value of at least 16 oz/in (18 g/mm) measured according to ASTM D1000-04.

TABLE 1
MATERIALS USED

| Ingredient | Product Name | Source |
|---|---|---|
| Acrylic Adhesive Polymer | Not Commercially | 3M Taiwan |
| (40% solids solution of 94/6 | Available | |
| 2-ethyl hexyl acrylate/ | | |
| acrylic acid copolymer in | | |
| ethyl acetate) | | |
| Rosin Ester Tackifier | SYLVALITE | Arizona Chemical, |
| | RE80HP | USA |
| Melamine Cyanurate Flame | MCA 300 | Greenyard, Taiwan |
| Retardant | | |
| Melamine Cyanurate Flame | CG-610 | Chemguard, Taiwan |
| Retardant | | |
| Aluminum Hypophosphinate | Phoslite B85AX | Italmatch, Italy |
| Flame Retardant | | |
| Aluminum Phosphinate Salt | OP935 | Clariant, Germany |
| Flame Retardant | | |
| Aluminum Acetylacetonate | AAA | Advantis Science |
| Crosslinking Agent | | Corporation, USA |
| Alumina Trihydrate (ATH) | Hymod M932-SG | Huber, USA |
| Flame Retardant | | |
| TiO₂ Filler | Titanium Dioxide | Aldrich, USA |

### Examples 1-2 and Comparative Examples C0-C3

Tape samples were constructed to illustrate various embodiments of the invention. To prepare tape samples for a given example or comparative example, the Acrylic Adhesive Polymer was prepared containing the ingredients identified in Table 1. For each adhesive sample composition, the ingredients of the amount and type indicated in Table 2 were mixed using a laboratory-size high intensity mixer in the presence of a solvent (heptane, ethyl acetate or a blend of both). Each sample also contained 0.4 phr of aluminum acetylacetonate crosslinking agent. The resulting composition was coated directly onto a primed 25 μm thick PET film using either a laboratory knife-coater to produce handspread samples or a pilot-size coater (equipped with a knife-coater) to produce a continuous coated film with a nominal coating thickness of about 25 μm. After coating, the samples were either placed in a forced-convection oven (in the case of the handspread samples) or continuously passed through a tunnel oven (in the case of the continuous film) to extract the solvent and dry the sample. The coated and dried samples were then cut or slit to produce 0.75 inch (1.9 cm) samples. The samples were subjected to the test methodologies described above and the results are indicated in Table 3 below.

TABLE 2

| | Al Phos | Al Phos | | MC FR | | ATH | TiO₂ | Tackifier | |
|---|---|---|---|---|---|---|---|---|---|
| | FR | Amount | MC FR | Amount | ATH | Amount | Amount | Amount | Thickness |
| Ex. | Type | (phr) ¹ | Type | (phr) | Type | (phr) | (phr) | (phr) | (μm) |
| 1 | B85AX | 30.0 | MCA 300 | 10.0 | none | 0 | 8.0 | 8.8 | 50 |
| 2 | B85AX | 30.0 | MCA 300 | 30.0 | none | 0 | 8.0 | 8.0 | 50 |
| C0 | None | 0 | none | 0 | none | 0 | 17.7 | 0 | 55 |
| C1 | none | 0 | MCA 300 | 80.0 | none | 0 | 0 | 8.0 | 59 |
| C2 | none | 0 | CG-610 | 35.0 | M932- | 8.3 | 11.8 | 7.23 | 54 |
| | | | | | SG | | | | |
| C3 | OP935 | 35.0 | none | 0 | none | 0 | 8.0 | 8.0 | 54 |

¹ Amount calculated on the basis of acrylic adhesive + tackifier + crosslinking agent
² Thickness of entire tape construction

TABLE 3

| | UL 510 | | UL 510 | |
|---|---|---|---|---|
| | Adhesion | | Dielectric | |
| | to Steel | UL 510 | Breakdown | CTI |
| Example | (oz/in) | Flamm. | Retention | Rating |
| 1 | 30 (PASS) | PASS | PASS | I |
| 2 | 28 (PASS) | PASS | PASS | I |
| C0 | 30 (PASS) | Failed | PASS | I |
| C1 | 19 (PASS) | Failed | PASS | N/A¹ |
| C2 | 35 (PASS) | PASS | PASS | II |
| C3 | 42 (PASS) | PASS | PASS | II |

¹Sample did not pass UL510, so a CTI Rating was not determined.

Examples 1 and 2 both pass industry standard UL 510 flammability testing and testing of dielectric breakdown retention (i.e., the wet dielectric strength is at least 90% of the dry dielectric strength). Both also achieve a CTI rating of I. The illustrated examples also offer flexibility, with the inclusion of additional additives, to control the level of adhesion.

Although the aforementioned detailed description contains many specific details for purposes of illustration, one of ordinary skill in the art will appreciate that many variations, changes, substitutions, and alterations to the details are within the scope of the invention as claimed. Accordingly, the invention described in the detailed description is set forth without imposing any limitations on the claimed invention. The proper scope of the invention should be determined by the following claims and their appropriate legal equivalents.

1. A composition comprising:
at least one adhesive; and
a flame retardant component,
wherein the flame retardant component comprises both a melamine cyanurate and an aluminum phosphinate.

2. The composition of claim 1, wherein the adhesive is one of a pressure sensitive adhesive and an acrylic adhesive.

3. (canceled)

4. The composition of claim 1, wherein the weight ratio of melamine cyanurate to aluminum phosphinate in the flame retardant component is about 1:3 to about 1:1.

5. The composition of claim 1, wherein the flame retardant component comprises from about 30 wt % to about 60 wt % of the flame retardant adhesive.

6. The composition of claim 1, wherein the aluminum phosphinate is an aluminum hypophosphite.

7. The composition of claim 1, wherein the adhesive has a CTI rating of I.

8. (canceled)

9. An article comprising a backing layer having two opposed, major surfaces, and the adhesive of claim 1 disposed on at least one of the major surfaces of the backing layer.

10. The article of claim 9, wherein the aluminum phosphinate is an aluminum hypophosphite.

11. The article of claim 9, wherein the tape has a CTI rating of I.

12. (canceled)

13. An article comprising a backing layer having two opposed, major surfaces, an adhesive disposed on at least one of the major surfaces of the backing layer, and a flame retardant component comprising a melamine cyanurate and an aluminum phosphinate, the flame retardant component being disposed in the backing layer, on the backing layer, or a combination thereof.

14. The article of claim 13, wherein the adhesive is one of a pressure sensitive adhesive and an acrylic adhesive.

15. (canceled)

16. The article of claim 13, wherein the weight ratio of melamine cyanurate to aluminum phosphinate in the flame retardant component is about 1:3 to about 1:1.

17. The article of claim 13, wherein the aluminum phosphinate is an aluminum hypophosphite.

18. The article of claim 13, wherein the tape has a CTI rating of I.

19. The article of claim 13, wherein the backing layer comprises a polyester, a polyolefin, a polyamide, or a polyimide.

20. (canceled)
